(19) United States
(12) Patent Application Publication
(10) Pub. No.: US 2009/0311529 A1
(43) Pub. Date: Dec. 17, 2009

(54) HIGH TENACITY THERMOPLASTIC POLYURETHANE MONOFILAMENT AND PROCESS FOR MANUFACTURING THE SAME

(75) Inventors: Heping ZHANG, Summerville, SC (US); Craig Valentine, Summerville, SC (US)

Correspondence Address: GREENBLUM & BERNSTEIN, P.L.C., 1950 ROLAND CLARKE PLACE, RESTON, VA, 20191, US

(73) Assignee: VOITH PATENT GmbH, Heidenheim (DE)

(21) Appl. No.: 12/139,903

(22) Filed: Jun. 16, 2008

(51) Int. Cl. D02G 3/00; D04H 3/00; B29C 55/00

(52) U.S. Cl. 428/401; 442/327; 264/164

(57) ABSTRACT

The present invention relates to a high tenacity polyurethane monofilament and a process for manufacturing the same, comprising of orienting and dynamic annealing of a polyurethane-containing monofilament. In addition to high tenacity, the present invention imparts reduced shrinkage and elongation to monofilament fibers, facilitating the use of thermoplastic elastomers in industrial fabrics, particularly in paper machine clothing (PMC). The brief abstract is neither intended to define the invention disclosed in this specification nor intended to limit the scope of the invention in any way.

### BACKGROUND OF THE INVENTION

1. Field of the Invention

The present invention relates to a high tenacity polyurethane monofilament and a process for manufacturing the same, comprising orienting and dynamic annealing of a thermoplastic polyurethane-monofilament.

2. Discussion of Background Information

Elastomers as raw materials provide various desirable properties to a monofilament. In addition to excellent chemical resistance and high dimensional stability (not sensitive to water), they have high compressability, excellent elastic recovery or resilience (repeatedly fast and full elastic recovery), excellent wear resistance, and good vibration damping.

Such characteristics of the elastomeric monofilaments provide a unique benefit as components in an industrial fabric, especially for a paper machine clothing (PMC) fabric. The main functions of a PMC fabric are carrying paper pulp, consolidating pulp into the form of paper (forming fabric), and facilitating water removal from the original pulp/water mixture in a high pressure press (press fabric). Due to their excellent elastic recovery property, elastomers when used in such fabrics assure effective water removal of the paper pulp without damaging the paper formation on the fabric. This is particularly important for modern paper machines where speeds may be in the excess of 2,000 meters per minute. The pressure applied to the fabric thus becomes higher and changes occur more rapidly.

The fabric is structured by either a weaving process or by other method (e.g. winding) to form a cloth and impart a machine direction (MD) and a cross machine direction (CMD). Monofilaments are the primary components or building blocks of the fabric. Requirement for an industrial fabric are that it needs to be stable under tension in both MD and CMD, whether tensile load is to drive (MD) or to hold the fabric (CMD). Its monofilament components therefore should possess very low tensile elasticity to limit its deformation under tension in its field application. Moreover, fabric weaving, winding, or any other method for fabric manufacturing process requires the monofilament to be stable under weaving tension. Therefore the monofilaments should have high tenacity, high modulus and very low elongation under tensile load. In addition, the monofilaments need to have low thermal shrinkage at elevated temperatures. This will ensure stability of the industrial fabric during heat-setting (a final fabric processing step used during manufacturing to remove the residual-weaving stress and to form crimps between MD and CMD monofilaments) and also in PMC application as the fabric is normally operated at a temperature higher than the room temperature.

There are two basic categories of elastomers: solvent based and thermoplastic. For making monofilaments, thermoplastic elastomers are better suited as solvent-based elastomer systems pose problems in removal of solvents after the monofilament is made. Unlike fibers whose diameters are in the micron range, the monofilaments have larger diameters, typically in the millimeter range, which, prevents effective solvent evaporation at the production time scale.

Thermoplastic polyurethanes (TPU), a member of the thermoplastic elastomer family are suitable for monofilament manufacturing. TPU, in comparison to other ethylene based elastomers, have better resilience, and better wear resistance, which as already stated is a requirement for industrial fabric application. Furthermore, its two phase polymer morphology can be adjusted during its processing to achieve high tenacity, high modulus, and low elongation with low thermal shrinkage.

U.S. Patent Application Publication No. 2002/0161159 describes the process of making thermoplastic polyurethane elastomer fiber. The disclosed process reveals how to maintain high molecular weight of the thermoplastic polyurethane during melt extrusion process. High molecular weight is important as it is a key factor to achieve high tenacity and other required mechanical properties. However, since the target application for thermoplastic polyurethane elastomers of the above mentioned patent was not industrial fabrics the parameters required to achieve a combination of high tenacity, high modulus, low elongation, and low thermal shrinkage were not the objectives of this patent.

There has been a need for high-tenacity and low-tensile-elasticity elastomeric monofilaments, which are suitable for industrial fabric, especially for paper machine clothing (PMC).

### SUMMARY OF THE INVENTION

The present invention provides a solution to the aforementioned problems. The present invention provides a TPU monofilament and a process for manufacturing the same. The TPU monofilament of this invention has high tenacity, high modulus, low tensile elongation, and low thermal shrinkage and its intended application is in industrial fabrics, especially in paper machine clothing (PMC).

In one aspect, the invention relates to an oriented, annealed thermoplastic elastomeric monofilament. Due to the orientation and/or dynamic annealing process, the oriented, annealed thermoplastic elastomer possesses distinct crystal structures that can be characterized by DSC as two crystalline melting peaks.

This oriented, annealed thermoplastic elastomer may have various desirable characteristics, including but not limited to: a tenacity ranging from about 2 grams per denier (gpd) to about 4 gpd; an elongation no greater than 50% at 1 gpd load, and preferably no greater than 20%; and a thermal shrinkage no greater than 30% at 140° C. (for 3 minutes), and preferably no greater than 20% at 140° C. (for 3 minutes).

The width of the monofilament forming this monofilament yarn may range from about 0.1 mm to about 1.5 mm, and may have a denier from about 80 to about 20,000.

An industrial fabric may be woven using at least one aforementioned monofilament. Various types of industrial fabrics may be made from the aforementioned monofilament, including but not limited to: paper machine clothing (PMC), that encompasses, press fabric, forming fabric, and dryer fabric.

The oriented, annealed thermoplastic elastomer in this invention is specifically thermoplastic polyurethane.

Another aspect of the present invention entails a method for manufacturing a high tenacity monofilament comprising of the following steps: (1) melting and extruding a thermoplastic elastomer and (2) orienting and dynamically annealing the thermoplastic elastomer. The process of orientation and dynamic annealing comprises of drawing the thermoplastic elastomer at three different drawing steps. At the end of this process, the thermoplastic elastomer exhibits at least two melting peaks in a DSC measurement.

The first drawing ratio may range from 2 to 6 and the first annealing temperature may range from 20° C. to 150° C. with the residence time ranging from 1 second to 2 minutes.

The second drawing ratio may range from 1.01 to 3 at an annealing between 50° C. to 200° C. and a residence time ranging from 1 second to 2 minutes.

The third drawing ratio may range from 0.8-1.0 and the third annealing temperature may range from 120° C. to 200° C. at a residence time ranging from 1 second minutes to 2 minutes.

The air flow velocity during the orientation and dynamic annealing may range from 10 m/min to 20 m/min.

The diameter of the monofilament may range from about 0.1 mm to about 1.5 mm, and the denier of the monofilament may range from about 80 to about 20,000.

Alternatively, in yet another embodiment, an industrial fabric may be woven from at least one aforementioned monofilament yarn. Various types of industrial fabrics may be made from the aforementioned monofilament yarn, including but not limited to: paper machine clothing encompassing press felt, forming fabric, and dryer fabric.

Other exemplary embodiments and advantages of the present invention may be ascertained by reviewing the present disclosure and the accompanying drawing.

### BRIEF DESCRIPTION OF THE DRAWINGS

The present invention is further described in the detailed description that follows, in reference to the noted plurality of drawings by way of non-limiting examples of exemplary embodiments of the present invention, in which like reference numerals represent similar parts throughout the several views of the drawings.

The FIGURE is a DSC thermogram, illustrating the effective change in the crystalline structure of the monofilament due to orientation and/or dynamic annealing.

### DETAILED DESCRIPTION OF THE PRESENT INVENTION

Unless otherwise stated, a reference to a compound or component includes the compound or component by itself as well as its combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

Before further discussion, a definition of the following terms will aid in the understanding of the present invention.

### DEFINITIONS

The terms used in this disclosure are defined as follows unless otherwise indicated. Standard terms are to be given their ordinary and customary meaning as understood by those of ordinary skill in the art, unless expressly defined herein.

As used herein, “orientation” refers to the process in which the TPU molecules are aligned causing changes in microstructure. It is well known that orientation-improves the tensile properties of an elastomer. A variety of drawing methods, known in the art, may be employed to orient the melt extruded elastomer (extrudates). These methods include (but are not limited to): (1) spin drawing; (2) solid-state drawing, and (3) combination of both.

As used herein, “spin drawing” entails drawing the elastomer as take-up draw immediately after extrusion and winding the elastomer onto a spool. The degree of drawing is typically expressed as the ratio of spinneret hole cross section area to the cross section area of the final wound yarn. The orientation is primarily developed in the semi-melt state at the take-up.

Drawing conditions and methods of optimizing those for elastomers are known in the art to change the product morphology which, in turn, leads to the properties required for the application. For example, it is known that “spinning draw” or take-up draw in semi-melt state can give better properties. These improved properties are a result of higher molecular orientation, due to the high shear forces on the molecules easily achieved during the semi-melt spinning process.

Solid state drawing is a process of passing the solidified polymer extrudate through a heated medium such that the polymer can be heated above its glass transition temperature for activating polymer molecules. A drawing tension is then applied on the extrudate which orinets the polymer molecules in the direction of the applied tension.

Polymer monofilaments can be subjected to solid state drawing in two or more separate steps. The total draw ratio is then the product of the individual draw ratios.

As used herein, “dynamic annealing” refers to a process in which the polymer crystals are formed during the continuous drawing (orientation) process. The residence time of the monofilaments passing through the oven, the heating medium (and hence the heat transfer rate), the relative speed of the air flow to the speed of the moving monofilament, and the total monofilament surface area exposed to the heating medium are the parameters involved in this annealing process.

As used herein, “oriented, annealed thermoplastic elastomer” refers to the elastomer produced from the orientation and dynamic annealing process described above. The resulting oriented, annealed thermoplastic elastomer has various desirable characteristics, including but not limited to: a tenacity of at least 1.5 gpd and preferably greater 3.0 gpd; an elongation at 1.0 gpd of at most 50% and preferably less than 20%; and a thermal shrinkage of at most 30% at 140° C. (for 3 minutes).

As used herein, “thermal shrinkage” refers to shrinkage observed due to increased temperatures (see ASTM D204 Standard Test Methods, “Shrinkage, Single Strand” test methods, for further details on experimental conditions for the thermal shrinkage test, the entirety of ASTM D204 is incorporated by reference herein). Thermal shrinkage may be measured in terms of the percent decrease in length that is observed under a given temperature. In the present invention, thermal shrinkage is observed by heating the monofilaments to 140° C. for 3 minutes.

The mechanical properties of the claimed elastomer monofilaments were determined according to ASDM D2256-97.

“Tenacity” refers to the unit tensile strength of the monofilament, calculated by dividing the tensile force at break by its linear density. In the present invention, tenacity is measured in a tensile tester at a strain rate of 100% under room temperature and humidity (typically, 25° C. and 60% humidity), and is expressed in units of grams breaking force per denier (“gpd”).

“Elongation” refers to the increase in length of a specimen during a tensile test at 100% strain rate. As used herein, elongation is measured in terms of the percent increase in length that was observed during a tensile test, and a specific elongation is the elongation at a given load. In the present invention, a specific elongation at 1 gpd load was observed. The elongation at 1 gpd is chosen to represent a typical weaving force during the industrial fabric manufacturing process

Drawing conditions and methods of optimizing them for elastomers are known in the art to change the product morphology which, in turn, result in desirable properties required for the application. For example, it is known that “spinning draw” or take-up draw in semi melt state can give better properties, due to ease of achieving higher shear forces during the semi-melt spinning process and hence higher molecular orientation.

As used herein, “industrial fabric” refers to a fabric woven or formed through any other process from the aforementioned monofilaments. Various types of industrial fabrics may be made from the aforementioned monofilament yarn, including but not limited to paper machine fabric that includes press felt, forming fabric, and dryer fabric.

### EXAMPLES

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

### Melting and Extruding Process

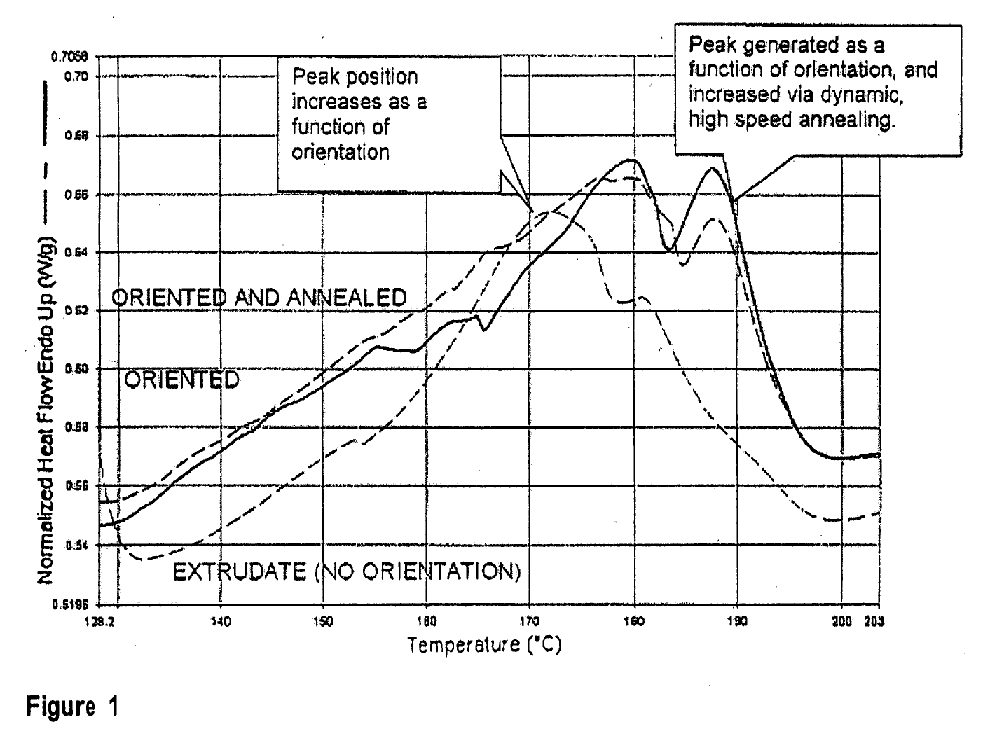

According to the exemplary process depicted in FIG. 1, a composition comprising 100% thermoplastic polyurethane (“TPU”), sold as Estane™ TPU (available from Lubrizol Corp.) 58157 with 57 D hardness was pre-dried at 220° F. for three hours. The dried resin was fed into a 25 mm single screw extruder. The melt temperature of the material at the extruder was 220° C.

The melted TPU was then extruded through the spinnerets attached at the end of the extruder to form extrudates. In this example, the spinneret holes had a diameter of 1.842 mm. The extrudates were quenched in water to freeze the size and the structure. In this example, the diameter of the extrudates was 0.95 mm and the take-up draw ratio was 3.76.

The tenacity and elongation properties of the extrudate were then measured. The results of these tests may be found in Table 2 below, which compares the extrudate with oriented elastomers and oriented, annealed elastomers. The crystalline structure of the extrudate was also measured and analyzed as shown in FIG. 1.

### Orientation Process

The extruded TPU was then drawn or oriented in its solid state by passing them through a series of godet rollers that were set up at different linear speed ratios. Table 1A provides exemplary apparent draw ratio for each of the three rollers (e.g., Apparent Draw Ratio 1, Apparent Draw Ratio 2, and Apparent Draw Ratio 3). The tenacity, elongation properties, and shrinkage of the oriented TPU was then measured (see Table 1B for results). The crystalline structure of the oriented TPU was also measured and analyzed using DSC thermogram shown in FIG. 1.

### Dynamic Annealing Process

The dynamic annealing process accompanied the drawing process providing heat to entail polymer micro-structure formation in the monofilament under stress (shown below in Table 1A). The residence time of the monofilaments in the heating oven, the heating medium, the relative speed between the air flow velocity and the monofilament traveling speed, and the total monofilament surface area exposed to the heating medium, are the parameters involved in the annealing process.

The heating medium in the pre-heated ovens can be circulating water or air, or steam Exemplary temperatures, in case of circulated air are provided below in Table 1A (e.g., Annealing Temperature 1, Annealing Temperature 2, and Annealing Temperature 3 correspond to the annealing temperatures used, as the monofilament is passed through the first, the second and the third oven). The tenacity, elongation properties, and shrinkage of the oriented, annealed TPU were then measured (see Table 2 for results). The crystalline structure of the oriented, annealed TPU was also measured and analyzed by DSC thermogram shown in FIG. 1.

TABLE 1A
TPU Monofilament Processing Conditions

| | Experiment No. | | | | | |
|---|---|---|---|---|---|---|
| | 1 | 2 | 3 | 4 | 5 | 6 |
| Extrusion Melt Temp. (° C.) | 220 | 220 | 220 | 220 | 220 | 220 |
| Solidification | 32 | 32 | 32 | 32 | 32 | 32 |
| Monofilament Denier | 1570 | 1570 | 1570 | 1570 | 1570 | 1570 |
| Line feed speed | 30 | 30 | 30 | 50 | 50 | 50 |
| Apparent Draw Ratio 1 | 3 | 3 | 3 | 4.5 | 4.5 | 4.5 |
| Apparent Draw Ratio 2 | 2.1 | 2.1 | 2.1 | 1.4 | 1.4 | 1.4 |
| Apparent Draw Ratio 3 | 0.9 | 0.9 | 0.9 | 0.9 | 0.9 | 0.9 |
| Annealing 1 Temp. | 76 | 76 | 132 | 76 | 76 | 76 |
| (° C.) | | | | | | |
| Annealing 2 Temp. | 121 | 132 | 150 | 121 | 132 | 121 |
| (° C.) | | | | | | |
| Annealing 3 Temp. | 132 | 150 | 150 | 132 | 150 | 132 |
| (° C.) | | | | | | |
| Air Flow 1 Velocity | 10 | 10 | 10 | 10 | 10 | 20 |
| (m/min) | | | | | | |
| Air Flow 2 Velocity | 10 | 10 | 10 | 10 | 10 | 20 |
| (m/min) | | | | | | |
| Air Flow 3 Velocity | 10 | 10 | 10 | 10 | 10 | 20 |
| (m/min) | | | | | | |
| Residence time 1 (sec.) | 2 | 2 | 4 | 2 | 2 | 2 |
| Residence time 2 (sec.) | 2 | 4 | 4 | 2 | 4 | 2 |
| Residence time 3 (sec.) | 2 | 4 | 4 | 2 | 4 | 2 |

TABLE 1B
Monofilament Properties

| | Experiment No. | | | | | |
|---|---|---|---|---|---|---|
| | 1 | 2 | 3 | 4 | 5 | 6 |
| Tenacity (gpd) | 2.1 | 2.2 | 1.8 | 3.6 | 3.8 | 3.2 |
| Elongation at 1 gpd (%) | 40 | 30 | 30 | 15 | 16 | 12 |
| Thermal Shrinkage at 140° C. | 25 | 25 | 20 | 15 | 10 | 10 |
| (%) | | | | | | |

TABLE 2

| | | | Oriented and |
|---|---|---|---|
| | Extrudate | Oriented | Annealed |
| Tenacity (gpd) | .6 | 1.5 | 3.8 |
| Elongation @ Break | 450 | 60 | 30 |
| (%) | | | |
| Elongation @ | — | 43 | 16 |
| 1.0 gpd (%) | | | |
| Shrinkage | 200 | 50 | 10 |
| (3 min @ | | | |
| 140 C.) (%) | | | |
| DSC Peak Position | Broad Peak at | Double peaks at | Distinct double |
| | 172° C. | 178° C. and | peaks, stronger |
| | | 187° C. | intensity at |
| | | | the peak |
| | | | at 187° C. |

The orientation and dynamic annealing process described herein significantly improves the thermo-mechanical properties of the claimed thermoplastic polyurethane monofilaments. For example, as described in example 1, the orientation and/or dynamic annealing processes minimize the tensile elongation of polyurethane while maintaining its resilience.

In the DSC (“Differential Scanning Calorimetry”) thermogram, two peaks are observed for the “oriented and annealed” filament. These two peaks represent at least two different size distribution of crystals in the elastomer's polymer structure. These crystals with a broad distribution in size, we believe, act as anchors to inhibit thermal shrinkage in filaments to acceptable levels. Furthermore, these crystals reinforce the mechanical properties for high tenacity, lower elongation, and higher modulus. Furthermore, the resulting highly-oriented, high-speed annealed, thermoplastic elastomer has improved compression and recovery properties, as well as enhanced abrasion resistance in perpendicular direction with respect to the monofilament drawing direction, while preventing excessive extension.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein. Rather, the present invention extends to all functionally equivalent structures, methods and uses, such as are within the scope of the appended claims.

The present invention has various uses, including but not limited to manufacture of paper machine clothing and other industrial fabrics that provide improved resilience and abrasion resistance in the vertical direction with respect to the fabric plane, and provide both thermal and mechanical stability under heat and load in fabric plane direction. The thermoplastic polyurethane monofilament also provide dimensional stability in wet conditions.

What is claimed is:

1. An oriented, annealed thermoplastic elastomeric monofilament wherein the oriented, annealed thermoplastic elastomer monofilament has a thermal shrinkage from about 10% to about 20% at 140° C., and wherein the thermoplastic elastomer monofilament exhibits at least two melting peaks in a DSC measurement.

2. The thermoplastic elastomer monofilament of claim 1, wherein the oriented, annealed thermoplastic elastomer has a tenacity ranging from about 2 gpd to about 4 gpd.

3. The oriented thermoplastic elastomer monofilament of claim 1, wherein the oriented, annealed thermoplastic elastomer has an elongation at 1.0 grams per denier load of no greater than 50%.

4. The oriented thermoplastic elastomer monofilament of claim 3, wherein the oriented, annealed thermoplastic elastomer has an elongation of no greater than 20% at 1.0 grams per denier load.

5. A monofilament yarn comprised of at least one monofilament comprising the oriented, annealed thermoplastic elastomer according to claim 1.

6. The monofilament yarn of claim 5, wherein the width of the monofilament ranges from about 0.1 mm to about 1.5 mm, and wherein the monofilament has a denier from about 80 to about 20,000.

7. An industrial fabric comprising at least one monofilament yarn according to claim 5, wherein the fabric is one of a paper machine fabric, a press felt, a forming fabric, and a dryer fabric.

8. The oriented, annealed thermoplastic elastomer according to claim 1 comprising thermoplastic polyurethane.

9. A method for the manufacturing a high tenacity monofilament comprising:
melting and extruding a thermoplastic elastomer, orienting and dynamically annealing the thermoplastic elastomer by: drawing the thermoplastic elastomer at a first drawing ratio, while heating the thermoplastic elastomer at a first annealing temperature,
drawing the thermoplastic elastomer at a second drawing ratio, while heating the thermoplastic elastomer at a second annealing temperature,
drawing the thermoplastic elastomer at a third drawing ratio, while heating the thermoplastic elastomer at a third annealing temperature, and wherein after the process the oriented, dynamically annealed thermoplastic elastomer is characterized by at least two melting peaks in a DSC measurement.

10. The method according to claim 9, wherein diameter of the monofilament ranges from about 0.1 mm to about 1.5 mm, and wherein denier of the monofilament ranges from about 80 to about 20,000.

11. The method according to claim 9, wherein denier of the monofilament ranges from about 80 to about 20,000, and wherein diameter of the monofilament ranges from about 0.1 mm to about 1.5 mm.

12. The method of claim 9, further comprising forming an industrial fabric from the monofilament yarn.

13. The method of claim 9, wherein the industrial fabric is one of a press felt, a forming fabric and a dryer fabric of paper machine clothing.
